(19) United States
(12) Patent Application Publication
(10) Pub. No.: US 2019/0141670 A1
(43) Pub. Date: May 9, 2019

(54) PAGING DETECTION WINDOW

(71) Applicant: NOKIA SOLUTIONS AND NETWORKS OY, Espoo (FI)

(72) Inventors: Frank Frederiksen, Klarup (DK); Claudio Rosa, Randers NV (DK); Esa Mikael Malkamaki, Espoo (FI)

(21) Appl. No.: 16/308,382

(22) PCT Filed: Jun. 1, 2017
(86) PCT No.: PCT/EP2017/063317

§ 371 Date: Dec. 7, 2018

(30) Foreign Application Priority Data
Jun. 10, 2016 (EP) PCT/EP2016/063292

(51) Int. Cl. H04W 68/00; H04W 68/02; H04W 74/08; H04W 72/04; H04W 16/14; H04W 24/08

(52) U.S. Cl. CPC H04W 68/005; H04W 68/02; H04W 24/08; H04W 72/0453; H04W 16/14; H04W 74/0808

(57) ABSTRACT

A method comprising detecting at a user equipment a downlink transmission in a selected cell of a mobile communication system within a paging occasion window comprising two or more transmission time intervals, wherein the downlink transmission is subject to a clear channel assessment procedure, determining a paging detection window comprising one or more transmission time intervals within the paging occasion window relative to the beginning of the detected downlink transmission, and monitoring the downlink transmission for receiving a paging message to the user equipment for the duration of the paging detection window or until the paging message is received, whichever occurs first.

### FIELD

The present invention relates to the field of wireless communications. More specifically, the present invention relates to methods, apparatus, systems and computer programs for detection of paging messages.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters, which shall be used for the connection are also typically defined. An example of attempts to solve the problems associated with the increased demands for capacity is an architecture that is known as the long-term evolution (LTE) of the Universal Mobile Telecommunications System (UMTS) radio-access technology. The LTE is being standardized by the 3rd Generation Partnership Project (3GPP). The various development stages of the 3GPP LTE specifications are referred to as releases. Certain releases of 3GPP LTE (e.g., LTE Rel-11, LTE Rel-12, LTE Rel-13, LTE Rel-14) are targeted towards LTE-Advanced (LTE-A). LTE-A is directed towards extending and optimizing the 3GPP LTE radio access technologies.

Communication systems may be configured to use a mechanism for aggregating radio carriers to support wider transmission bandwidth. In LTE this mechanism is referred to as carrier aggregation (CA). A communication device with reception and/or transmission capabilities for CA can simultaneously receive and/or transmit on multiple component carriers (CCs) corresponding to multiple serving cells, for which the communication device has acquired/monitors system information needed for initiating connection establishment. When CA is configured, the communication device has only one radio resource control (RRC) connection with the network. At RRC connection establishment/reestablishment or handover, one serving cell provides the non-access stratum (NAS) mobility information, such as tracking area identity information. At RRC connection (re)establishment or handover, one serving cell provides the security input. This cell is referred to as the primary serving cell (PCell), and other cells are referred to as the secondary serving cells (SCells). Depending on capabilities of the communication device, SCells can be configured to form together with the PCell a set of serving cells under CA. In the downlink, the carrier corresponding to the PCell is the downlink primary component carrier (DL PCC), while in the uplink it is the uplink primary component carrier (UL PCC). A SCell needs to be configured by the network using RRC signaling before usage in order to provide necessary information, such as DL radio carrier frequency and physical cell identity (PCI) information, to the communication device. A SCell for which such necessary information has been provided to a communication device is referred to as configured cell for this communication device. The information available at the communication device after cell configuration is in particular sufficient for carrying out cell measurements. A configured SCell is in a deactivated state after cell configuration for energy saving. When a SCell is deactivated, the communication device does in particular not monitor/receive the physical dedicated control channel (PDCCH) or enhanced physical dedicated control channel (EPDCCH) or physical downlink shared channel (PDSCH) in the SCell. In other words the communication device cannot communicate in a SCell after cell configuration, and the SCell needs to be activated before data transmission from/the communication device can be initiated in the SCell. LTE provides for a mechanism for activation and deactivation of SCells via media access control (MAC) control elements to the communication device.

Communication systems may be configured to support simultaneous communication with two or more access nodes. In LTE this mechanism is referred to as dual connectivity (DC). More specifically, a communication device may be configured in LTE to communicate with a master eNB (MeNB) and a secondary eNB (SeNB). The MeNB may typically provide access to a macrocell, while the SeNB may provide on a different radio carrier access to a relatively small cell, such as a picocell. Only the MeNB maintains for the communication device in DC mode a connection via an S1-MME interface with the mobility management entity (MME), that is, only the MeNB is involved in mobility management procedures related to a communication device in DC mode. LTE supports two different user plane architectures for communication devices in DC mode. In the first architecture (split bearer) only the MeNB is connected via an S1-U interface to the serving gateway (S-GW) and the user plane data is transferred from the MeNB to the SeNB via an X2 interface. In the second architecture the SeNB is directly connected to the S-GW, and the MeNB is not involved in the transport of user plane data to the SeNB. DC in LTE reuses with respect to the radio interface concepts introduced for CA in LTE. A first group of cells, referred to as master cell group (MCG), can be provided for a communication device by the MeNB and may comprise one PCell and one or more SCells, and a second group of cells, referred to as seconday cell group (SCG), is provided by the SeNB and may comprise a primary SCell (PSCell) with functionality similar to the PCell in the MCG, for example with regard to uplink control signaling from the communication device. This second group of cells may further comprise one or more SCells.

Future networks, such as 5G, may progressively integrate data transmissions of different radio technologies in a communication between one or more access nodes and a communication device. Accordingly, communication devices may be able to operate simultaneously on more than one radio access technology, and carrier aggregation and dual connectivity may not be limited to the use of radio carriers of only one radio access technology. Rather, aggregation of radio carriers according to different radio access technologies and concurrent communication on such aggregated carriers may be supported.

Small cells, such as picocells, may progressively be deployed in future radio access networks to match the increasing demand for system capacity due to the growing population of communication devices and data applications. Integration of radio access technologies and/or a high number of small cells may bring about that a communication device may detect more and more cells in future networks, which are suitable candidates for connection establishment. Enhancements of carrier aggregation and dual connectivity mechanisms may be needed to make best use of these cells in future radio access networks. Such enhancements may allow for an aggregation of a high number of radio carriers at a communication device, for example up to 32, and in particular an integration of radio carriers operated on unlicensed spectrum.

Aggregation of radio carriers for communication to/from a communication device and simultaneous communication with two or more access nodes may in particular be used for operating cells on unlicensed (license exempt) spectrum. Wireless communication systems may be licensed to operate in particular spectrum bands. A technology, for example LTE, may operate, in addition to a licensed band, in an unlicensed band. LTE operation in the unlicensed spectrum may be based on the LTE Carrier Aggregation (CA) framework where one or more low power secondary cells (SCells) operate in the unlicensed spectrum, and may support either downlink-only or both uplink (UL) and downlink (DL) transmission, while the primary cell (PCell) may operate in the licensed spectrum. The cells may be operated in LTE Frequency Division Duplex (FDD) mode or LTE Time Division Duplex (TDD) mode.

Two proposals for operating in unlicensed spectrum are LTE Licensed-Assisted Access (LAA) and LTE in Unlicensed Spectrum (LTE-U). LTE-LAA specified in 3GPP as part of Rel. 13 and LTE-U as defined by the LTE-U Forum may imply that a connection to a licensed band is maintained while using the unlicensed band. Moreover, the licensed and unlicensed bands may be operated together using, e.g., carrier aggregation or dual connectivity. For example, carrier aggregation between a primary cell (PCell) on a licensed band and one or more secondary cells (SCells) on unlicensed band may be applied, and uplink control information of the SCells is communicated in the PCell on licensed spectrum.

In an alternative proposal stand-alone operation using unlicensed carrier only may be used. In standalone operation at least some of the functions for access to cells on unlicensed spectrum and data transmission in these cells are performed without or with only minimum assistance or signaling support from license-based spectrum. Dual connectivity operation for unlicensed bands can be seen as an example of the scenario with minimum assistance or signaling from licensed-based spectrum.

Unlicensed band technologies may need to abide by certain rules, e.g. a clear channel assessment procedure, such as Listen-Before-Talk (LBT), in order to provide fair coexistence between LTE and other technologies such as Wi-Fi as well as between LTE operators. In some jurisdictions respective rules may be specified in regulations.

In LTE-LAA, before being permitted to transmit, a user or an access node (such as eNodeB) may, depending on rules or regulatory requirements, need to perform a Clear Channel Assessment (CCA) procedure, such a Listen-Before-Talk (LBT). The user or access node may, for example, monitor a given radio frequency, i.e. carrier, for a short period of time to ensure that the spectrum is not already occupied by some other transmission. The requirements for CCA procedures, such as LBT, vary depending on the geographic region: e.g. in the US such requirements do not exist, whereas in e.g. Europe and Japan the network elements operating on unlicensed bands need to comply with LBT requirements. Moreover, CCA procedures, such as LBT, may be needed in order to guarantee co-existence with other unlicensed band usage in order to enable e.g. fair co-existence with Wi-Fi also operating on the same spectrum and/or carriers. After a successful CCA procedure the user or access node is allowed to start transmission within a transmission opportunity. The maximum duration of the transmission opportunity may be preconfigured or may be signaled in the system, and may extend over a range of, for example, 4 to 13 milliseconds. The access node may be allowed to schedule downlink (DL) transmissions from the access node and uplink (UL) transmissions to the access node within a certain time window. An uplink transmission may not be subject to a CCA procedure, such as LBT, if the time between a DL transmission and a subsequent UL transmission is less than or equal to a predetermined value. Moreover, certain signaling rules, such as Short Control Signaling (SCS) rules defined for Europe by ETSI, may allow for the transmission of control or management information without LBT operation, if the duty cycle of the related signaling does not exceed a certain threshold, e.g. 5%, within a specified period of time, for example 50 ms. The aforementioned SCS rules, for example, can be used by compliant communication devices, referred to as operating in adaptive mode for respective SCS transmission of management and control frames without sensing the channel for the presence of other signals. The term “adaptive mode” is defined in ETSI as a mechanism by which equipment can adapt to its environment by identifying other transmissions present in a band, and addresses a general requirement for efficient operation of communications systems on unlicensed bands. Further, scheduled UL transmissions may in general be allowed without LBT, if the time between a DL transmission from an access node and a subsequent UL transmission is less than or equal to a predetermined value, and the access node has performed a clear channel assessment procedure, such as LBT, prior to the DL transmission. The total transmission time covering both DL transmission and subsequent UL transmission may be limited to a maximum burst or channel occupancy time. The maximum burst or occupancy time may be specified, for example, by a regulator.

Data transmission on an unlicensed band or/and subject to a clear channel assessment procedure cannot occur pursuant to a predetermined schedule in a communication system. Rather, communication devices and access nodes need to determine suitable time windows for uplink transmission and/or downlink transmission. A respective time window may comprise one or more transmission time intervals (TTI), such as subframes in LTE, and is in the following referred to as uplink transmission opportunity or downlink transmission opportunity. A TTI is the time period reserved in a scheduling algorithm for performing a data transmission of a dedicated data unit in the communication system. The determination of uplink transmission opportunities and/or downlink transmission opportunities may be based on parameters related to the communication system, such as a configured pattern governing the sequence of uplink and downlink transmissions in the system. The determination may further be based on rules or regulations specifying a minimum and/or maximum allowed length of uplink transmissions and/or downlink transmissions. The determination of uplink and downlink opportunities may in particular be based on the outcome of a clear channel assessment procedure, and communication devices or access nodes will only start data transmission on a frequency band after having assessed that the frequency band is clear, that is, not occupied by data transmissions from other communication devices or access nodes. Further rules or regulations may govern data transmissions in a communication between an access node and one or more communication devices. These rules may, for example, specify a maximum length of a time window in the communication covering at least one transmission in a first direction, for example in DL in a cellular system from an access node of a cell, and at least one subsequent transmission in the reverse direction, for example in UL from one or more communication devices in the cell. Such a time window comprising one or more DL and UL transmissions may be referred to as communication opportunity. DL transmissions may comprise scheduling information which may be transmitted on a DL control channel. The scheduling information may in particular be used for scheduling one or more UL data transmissions and/or one or more DL data transmissions within the current one or more future communication opportunities.

Scheduling information for a data transmission is indicative of an assignment of contents attributes, format attributes and mapping attributes to the data transmission. Mapping attributes relate to one or more channel elements allocated to the transmission on the physical layer. Specifics of the channel elements depend on the radio access technology and may depend on the used channel type. A channel element may relate to a group of resource elements, while each resource element relates to a frequency attribute, for example a subcarrier index (and the respective frequency range) in a system employing orthogonal frequency-division multiplexing (OFDM), and a time attribute, such as the transmission time of an OFDM or Single-Carrier FDMA symbol. A channel element may further relate to a code attribute, such as a cover code or a spreading code, which may allow for parallel data transmission on the same set of resource elements. Illustrative examples for channel elements in LTE are control channel elements (CCE) on the physical downlink control channel (PDCCH) or the enhanced physical downlink control channel (EPDCCH), PUCCH resources on the physical uplink control channel (PUCCH), and physical resource blocks (PRB) on the physical downlink shared channel (PDSCH) and the physical uplink shared channel (PUSCH). It should be understood that each data transmission is associated with the code attributes of the allocated channel elements and the frequency and time attributes of the resource elements in the allocated channel elements. Format attributes relate to the processing of a set of information bits in the transmission prior to the mapping to the allocated channel elements. Format attributes may in particular comprise a modulation and coding scheme used in the transmission and the length of the transport block in the transmission. Contents attributes relate to the user/payload information conveyed through the transmission. In other words, a contents attribute is any information, which may in an application finally affect the arrangement of a detected data sequence at the receiving end. Contents attributes may comprise the sender and/or the receiver of the transmission. Contents attributes may further relate to the information bits processed in the transmission, for example some kind of sequence number in a communication. Contents attributes may in particular indicate whether the transmission is a retransmission or relates to a new set of information bits. In case of a hybrid automatic repeat request (HARQ) scheme contents attributes may in particular comprise an indication of the HARQ process number, that is, a HARQ-specific sequence number, the redundancy version (RV) used in the transmission and a new data indicator (NDI).

Scheduling information for a data transmission need not comprise assignment information for the complete set of attributes needed in the data transmission. At least a part of the attributes can be preconfigured, for example through semi-persistent scheduling, and can be used in more than one data transmission. Some of the attributes may be signaled implicitly or may be derivable, for example from timing information. However, dynamic scheduling in a more complex system, such as a cellular mobile network, requires transmission of scheduling information on a DL control channel. In a system employing carrier aggregation the DL scheduling information related to a certain data transmission may be transmitted on a component carrier other than the data transmission. Transmission of a data and scheduling information on different component carriers is referred to as cross-carrier scheduling.

In a cell operated on unlicensed spectrum a communication device may start monitoring channel elements related to a DL control channel carrying scheduling information after detection of DL data burst or subframe in the cell. The detection of the DL data burst or subframe may be based on the detection of a certain signal in the cell, for example a reference signal, such as a cell reference signal which the communication device may blindly detect, or based on explicit signaling indicative of the presence of the DL data burst (such as common DCI). Monitoring channel elements related to a DL control channel may comprise blind detection of scheduling information destined to the communication device. The control channel may be a physical downlink control channel (PDCCH) or enhanced physical downlink control channel (EPDCCH) as specified in LTE or a similar channel. The communication device may further detect a DL data transmission on a data channel, such as a physical downlink shared channel (PDSCH) or a similar channel, based on the detected scheduling information.

A communication device may need to monitor DL transmissions for detecting paging messages. Paging messages are in particular used in mobile communication systems for network-initiated connection setup when the terminal is in idle mode, such as RRC_IDLE mode in LTE. The location of a communication device being paged may not be known to the network on cell-level, and paging messages may therefore be transmitted in a wider network area. In LTE this wider network area is referred to as tracking area. A tracking area in LTE comprises a group of cells, and a communication device in RRC_IDLE mode needs to register its current tracking area, i.e. the tracking area comprising the cell the communication device is currently camping on, with the network. Paging messages may be transmitted on dedicated channels or on shared data channels. A downlink control channel, such as a physical downlink control channel (PDCCH) or an enhanced physical downlink control channel (EPDCCH) in LTE, may be used to inform one or more communication devices in a cell about transmitted paging messages. The communication device may use a specific identifier, such as the P-RNTI in LTE, to search for respective scheduling information on the downlink control channel. The transmission of paging messages in a cell may support discontinuous reception (DRX) for power-saving reasons, in which communication devices stay in a sleep mode most of the time and only wake up at predefined time instants to detect or search for paging messages. Specifically, paging messages destined for one or more communication devices may be transmitted from an access node during a paging occasion or paging occasion window.

Paging occasions or paging occasion windows may occur according to a preconfigured or predetermined configuration. In LTE, for example, a communication devices wakes up in one radio frame of a DRX cycle. The system frame number of the radio frame depends on the international mobile subscriber identity (IMSI) of the communication device. Within this radio frame, the communication device inspects a subframe, which also depends on the IMSI. This subframe is referred to as paging occasion in LTE. The communication device processes a paging message transmitted in this subframe, if it finds in the subframe scheduling information addressed to the P-RNTI on PDCCH or EPDCCH. Specific communication devices sharing the same paging occasion can be addressed in LTE through identity information (S-TMSI or IMSI) in the paging message.

In a system operated on unlicensed spectrum the time instances when paging messages are actually transmitted from an access node cannot be ensured if transmissions comprising potential paging messages are, in contrast to LTE, subject to the outcome of CCA procedures at the access node. Rather, the access node will postpone transmission bursts comprising potential paging messages until the CCA procedure indicates a free DL channel. Therefore, paging occasion windows may be used in such a system which extend over a sufficient length to accommodate potential transmission delays. On the other hand, DL transmissions from an access node in a paging occasion window need not contain a paging message or paging messages may only be conveyed in a part of the transmission burst. Monitoring a transmission burst over the whole paging occasion window may therefore lead to useless power consumption in the communication devices. Preferably, a communication device in idle mode monitors DL transmissions from an access node only when and if a paging message is transmitted in a paging occasion window.

Therefore, there is a need in systems employing a CCA procedure for a mechanism which ensures that active periods of a communication device in idle mode are reduced during paging occasion windows.

### SUMMARY

In a first aspect, there is provided a method comprising detecting at a user equipment a downlink transmission in a selected cell of a mobile communication system within a paging occasion window comprising two or more transmission time intervals, wherein the downlink transmission is subject to a clear channel assessment procedure; determining a paging detection window comprising one or more transmission time intervals within the paging occasion window relative to the beginning of the detected downlink transmission; and monitoring the downlink transmission for receiving a paging message to the user equipment for the duration of the paging detection window or until the paging message is received, whichever occurs first.

The method may further comprise receiving first configuration information of the paging detection window in broadcast information provided in the mobile communication system, and storing of the first configuration information.

The first configuration information may be cell-specific configuration information.

The first configuration information may comprise at least one of:
information indicative of the length of the paging detection window, and
information indicative of the beginning of the paging detection window.

The method may further comprising receiving and storing second configuration information of the paging detection window.

The second configuration information may be user-specific configuration information.

The second configuration information may comprise at least one of:
information indicative of the length of the paging detection window, and
information indicative of the beginning of the paging detection window.

The method may further comprising using information from the second configuration information, if available.

The user equipment is may be in idle mode in an embodiment of a method according to the first aspect.

In a second aspect, there is provided a method comprising causing a downlink transmission from an access node in a cell of a mobile communication system within a paging occasion window comprising two or more transmission time intervals, wherein the downlink transmission is subject to a clear channel assessment procedure; determining a paging detection window comprising one or more transmission time intervals within the paging occasion window relative to the beginning of the downlink transmission; and causing transmission of a paging message to a user equipment within the paging detection window.

The method may further comprise causing transmission of first configuration information of the paging detection window to the user equipment in broadcast information provided in the mobile communication system.

The first configuration information may be cell-specific configuration information.

The first configuration information may comprise at least one of:
information indicative of the length of the paging detection window, and
information indicative of the beginning of the paging detection window.

The method may further comprise causing transmission of second configuration information of the paging detection window to the user equipment.

The second configuration information may be user-specific configuration information.

The second configuration information may comprise at least one of:
information indicative of the length of the paging detection window, and
information indicative of the beginning of the paging detection window.

The method may further comprise using information from the second configuration information, if available.

The user equipment is may be in idle mode in an embodiment of a method according to the second aspect.

In a third aspect, there is provided an apparatus, said apparatus comprising at least one processor; and at least one memory including computer program code, the at least one memory and the computer program code configured, with the at least one processor, to cause the apparatus at least to detect at a user equipment a downlink transmission in a selected cell of a mobile communication system within a paging occasion window comprising two or more transmission time intervals, wherein the downlink transmission is subject to a clear channel assessment procedure; determine a paging detection window comprising one or more transmission time intervals within the paging occasion window relative to the beginning of the detected downlink transmission; and monitor the downlink transmission for receiving a paging message to the user equipment for the duration of the paging detection window or until the paging message is received, whichever occurs first.

The at least one memory and the computer program code may be further configured, with the at least one processor, to cause the apparatus at least to receive first configuration information of the paging detection window in broadcast information provided in the mobile communication system; and store the first configuration information.

The first configuration information may be cell-specific configuration information.

The first configuration information may comprise at least one of:
information indicative of the length of the paging detection window, and
information indicative of the beginning of the paging detection window.

The at least one memory and the computer program code may be further configured, with the at least one processor, to cause the apparatus to receive and store second configuration information of the paging detection window.

The second configuration information may be user-specific configuration information.

The second configuration information may comprise at least one of:
information indicative of the length of the paging detection window, and
information indicative of the beginning of the paging detection window.

The at least one memory and the computer program code may be further configured, with the at least one processor, to cause the apparatus to use information from the second configuration information, if available.

The user equipment is may be in idle mode in an embodiment of an apparatus according to the third aspect.

In a forth aspect, there is provided an apparatus, said apparatus comprising at least one processor; and at least one memory including computer program code, the at least one memory and the computer program code configured, with the at least one processor, to cause the apparatus at least to determine a paging detection window comprising one or more transmission time intervals within the paging occasion window relative to the beginning of the downlink transmission; and cause transmission of a paging message to a user equipment within the paging detection window.

The at least one memory and the computer program code may be further configured, with the at least one processor, to cause the apparatus to cause transmission of first configuration information of the paging detection window to the user equipment in broadcast information provided in the mobile communication system.

The first configuration information may be cell-specific configuration information.

The first configuration information may comprise at least one of:
information indicative of the length of the paging detection window, and
information indicative of the beginning of the paging detection window.

The at least one memory and the computer program code may be further configured, with the at least one processor, to cause the apparatus to cause transmission of second configuration information of the paging detection window to the user equipment.

The second configuration information may user-specific configuration information.

The second configuration information may comprise at least one of:
information indicative of the length of the paging detection window, and
information indicative of the beginning of the paging detection window.

The at least one memory and the computer program code may be further configured, with the at least one processor, to cause the apparatus to use information from the second configuration information, if available.

The user equipment is may be in idle mode in an embodiment of an apparatus according to the forth aspect.

In a fifth aspect, there is provided an apparatus comprising means for performing a method according to embodiments of the first aspect.

In a sixth aspect, there is provided an apparatus comprising means for performing a method according to embodiments of the second aspect.

In a seventh aspect, there is provided a computer program embodied on a non-transitory computer-readable storage medium, the computer program comprising program code for controlling execution of a process, and the process comprising detecting at a user equipment a downlink transmission in a selected cell of a mobile communication system within a paging occasion window comprising two or more transmission time intervals, wherein the downlink transmission is subject to a clear channel assessment procedure; determining a paging detection window comprising one or more transmission time intervals within the paging occasion window relative to the beginning of the detected downlink transmission; and monitoring the downlink transmission for receiving a paging message to the user equipment for the duration of the paging detection window or until the paging message is received, whichever occurs first.

In an eighth aspect, there is provided a computer program embodied on a non-transitory computer-readable storage medium, the computer program comprising program code for controlling execution of a process, and the process comprising causing a downlink transmission from an access node in a cell of a mobile communication system within a paging occasion window comprising two or more transmission time intervals, wherein the downlink transmission is subject to a clear channel assessment procedure; determining a paging detection window comprising one or more transmission time intervals within the paging occasion window relative to the beginning of the downlink transmission; and causing transmission of a paging message to a user equipment within the paging detection window.

In a ninth aspect, there is provided a computer program product for a computer, comprising software code portions for performing the steps of a method according to embodiments of the first aspect.

In a tenth aspect, there is provided a computer program product for a computer, comprising software code portions for performing the steps of a method according to embodiments of the second aspect.

In an eleventh aspect, there is provided a mobile communication system comprising at least one apparatus according to the third aspect and at least one apparatus according to the forth aspect.

In a twelfth aspect, there is provided a mobile communication system comprising at least one apparatus according to the fifth aspect and at least one apparatus according to the sixth aspect.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a base station and a plurality of communication devices;

FIG. 2 shows a schematic diagram of an example mobile communication device;

FIG. 3 shows an example method of a mobile communication device for receiving a paging message;

FIG. 4 shows an example method of an access node for transmitting a paging message;

FIG. 5 shows a schematic diagram illustrating transmission of a paging message according to a first example of the present invention;

FIG. 6 shows a schematic diagram illustrating transmission of a paging message according to a second example of the present invention;

FIG. 7 shows a schematic diagram illustrating transmission of a paging message according to a third example of the present invention;

FIG. 8 shows a schematic diagram of an example control apparatus;

### DETAILED DESCRIPTION

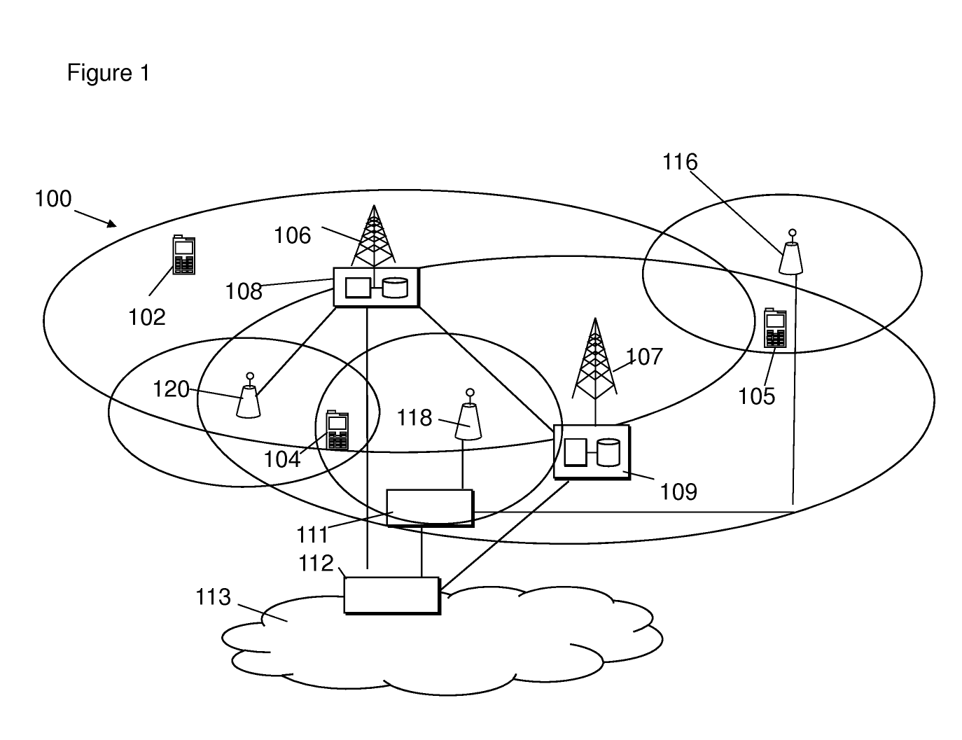

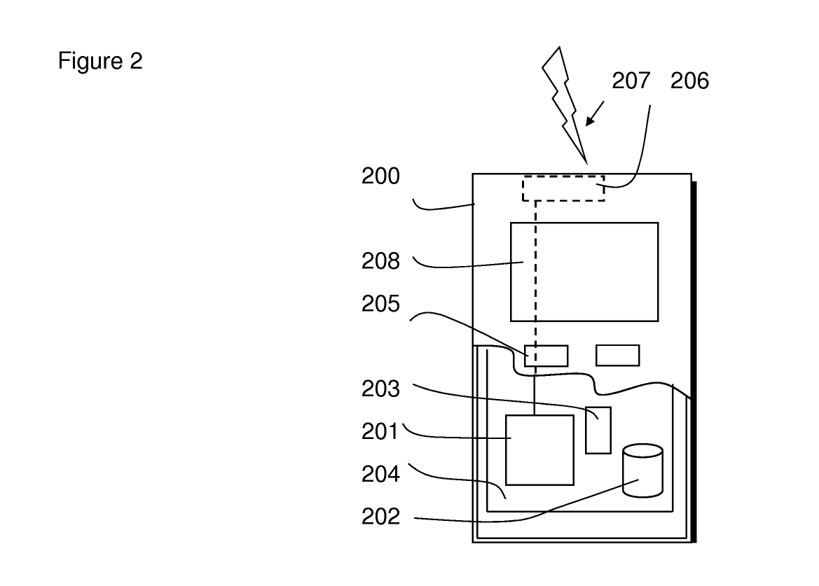

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, mobile communication devices or user equipment (UE) 102, 104, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example WLAN and may be WLAN APs.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on. Signaling mechanisms and procedures, which may enable a device to address in-device coexistence (IDC) issues caused by multiple transceivers, may be provided with help from the LTE network. The multiple transceivers may be configured for providing radio access to different radio technologies.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as wireless local area network (WLAN) and/or WiMax (Worldwide Interoperability for Microwave Access). A base station can provide coverage for an entire cell or similar radio service area.

As discussed above, there is a need in systems employing a CCA procedure for a mechanism which ensures that active periods of a communication device in idle mode are reduced during paging occasion windows.

Such a mechanism may comprise the determination of a paging detection window within the paging occasion window. The paging detection window may be determined based on configuration information relative to the beginning of a DL data burst within the paging occasion window.

The beneficial effect of such a mechanism is to be seen in that a communication device in idle mode needs to activate its transceiver apparatus in a paging occasion window only until it has detected the beginning of the DL data burst and further within the determined paging detection window or within the determined paging detection window until it has detected the paging message in the paging detection window.

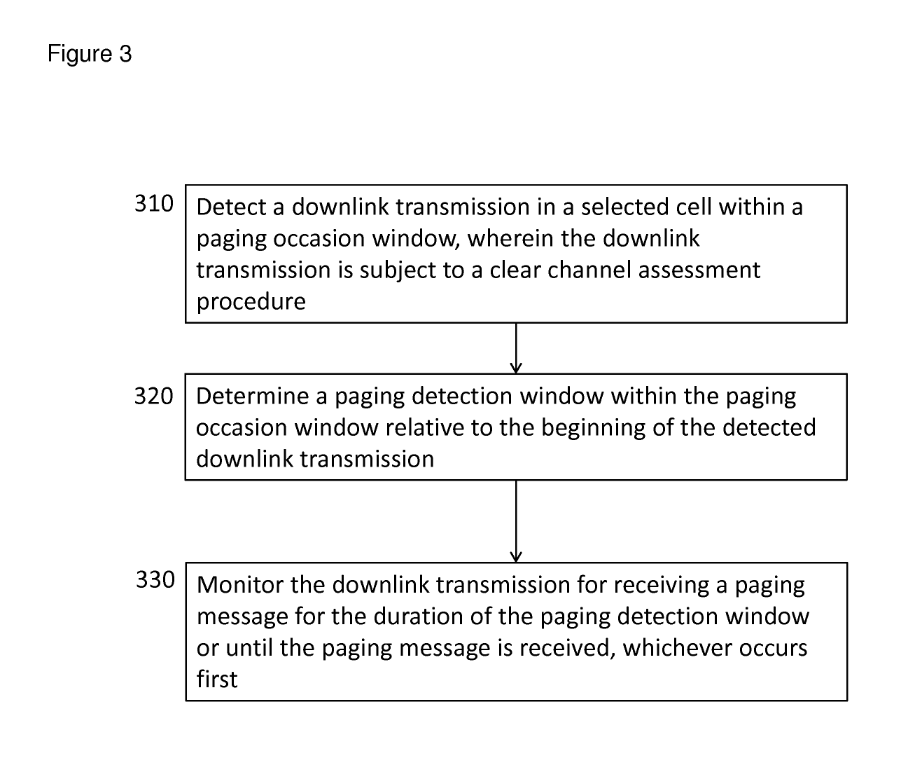

FIG. 3 shows an example method of a communication device for receiving a paging message.

At step 310, the communication device detects a DL transmission in a selected cell of a mobile communication system within a paging occasion window. The DL transmission may be subject to a successful clear channel assessment procedure at the access node. The paging occasion window may comprise two or more transmission time intervals, for example 10 subframes in a LTE-based system. The method proceeds to step 320.

At step 320, the communication device determines a paging detection window within the paging occasion window relative to the beginning of the detected DL transmission. The paging detection window may be determined based on received or predetermined or preconfigured configuration information. The method proceeds to step 330.

At step 330, the communication device monitors the DL transmission for receiving a paging message within the paging detection window. The communication may monitor the DL transmission for the duration of the paging detection window or until the paging message is received, whichever occurs first.

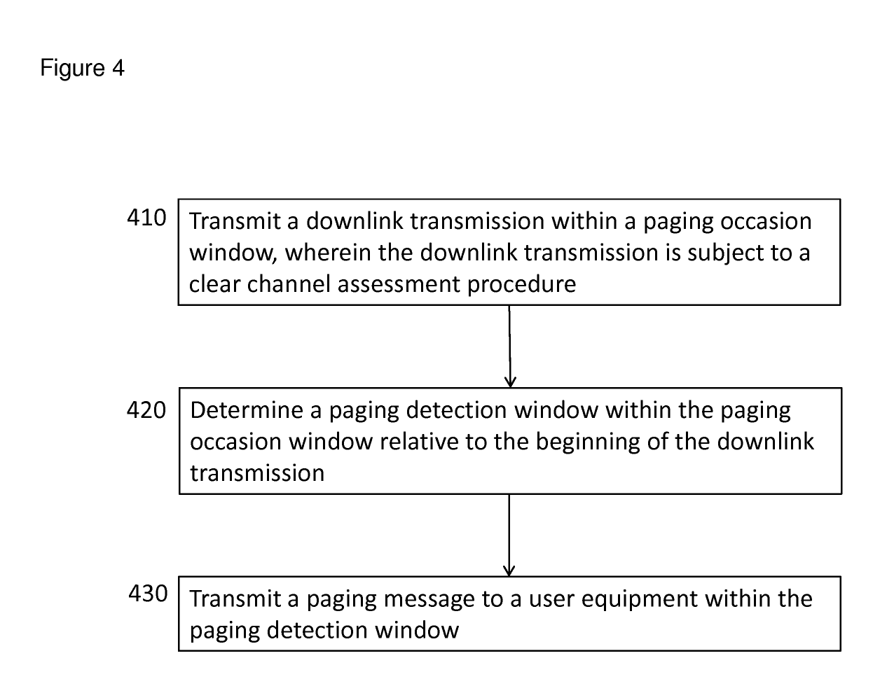

FIG. 4 shows an example method of an access node for transmitting a paging message.

At step 410, the access node transmits a DL transmission in a cell of a mobile communication system within a paging occasion window. The DL transmission may be subject to a successful clear channel assessment procedure at the access node. The paging occasion window may comprise two or more transmission time intervals, for example 10 subframes in a LTE-based system. The method proceeds to step 420.

At step 420, the access node determines a paging detection window within the paging occasion window relative to the beginning of the DL transmission. The paging detection window may be determined based on predetermined or preconfigured configuration information or configuration information signaled to a communication device. The method proceeds to step 430.

At step 430, the access node transmits a paging message to the communication device within the paging detection window determined in step 420.

The determination of the paging detection window in steps 320 and 420 may be based on first configuration information. This first configuration information may be broadcast in the communication system, for example broadcast in system information, such as system information blocks (SIBs) in LTE, in the cells of the communication system.

The first configuration information may be cell-specific configuration and may be applied to all communication devices camping on a cell, i.e. all communication devices in idle mode monitoring the system information in the cell after cell selection.

The first configuration information may comprise an indication indicative of the length of the paging detection window. Paging information may be transmitted with high priority within a paging occasion window and the access node may transmit paging messages in the paging occasion window once it has gained access to the channel. Therefore, it may be sufficient to specify only a length field in the configuration information, and the beginning of the paging detection window may be aligned with the beginning of the DL transmission in the paging occasion window. The first configuration information may, alternatively or additionally, comprise an indication indicative of the beginning of the paging detection window relative to the beginning of the DL transmission in the paging occasion window. Such an offset information provides additional flexibility. The offset information may, for example, be used to transmit updated system information in a paging occasion window prior to the transmission of paging messages.

The determination of the paging detection window in steps 320 and 420 may be based additionally or alternatively on second configuration information. A communication device may have received the second configuration information on a dedicated channel, for example, before it was set in idle mode.

The second configuration information may therefore be user-specific configuration and may be applied to a communication device or a group of communication devices camping on a cell.

The second configuration information may comprise an indication indicative of the length of the paging detection window. The second configuration information may, alternatively or additionally, comprise an indication indicative of the beginning of the paging detection window relative to the beginning of the DL transmission in the paging occasion window. This offset information may, for example, be used to distribute paging messages over the paging occasion window regardless of identity information of communication devices, such as the IMSI in LTE.

If available, second configuration information may be used for the transmission of paging messages to a communication device, while first configuration information may only provide a default configuration.

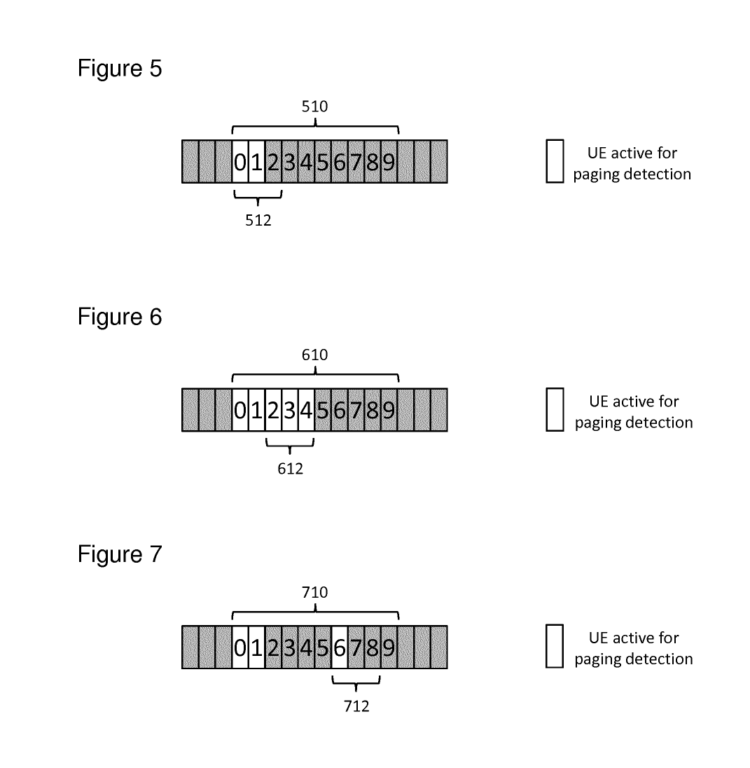

FIG. 5 shows a schematic diagram illustrating the transmission of a paging message according to a first example of the present invention. The paging occasion window 510 extends over TTIs 0 to 9, for example subframes 0 to 9 in a radio frame in a LTE-based system. The length of the paging detection window 512 is set to 3 TTIs. The paging detection window starts at TTI 0, i.e. the CCA procedure at the access node was successful in TTI 0 and the access node starts DL transmission in TTI 0. The paging message is received and detected by the communication device in TTI 1 in the paging detection window 512. After successful detection of the paging message in TTI 1 the communication device deactivates its transceiver apparatus. In other words, the communication device wakes up in TTI 0 for paging detection and stays active until and in TTI 1 for paging detection, before it deactivates its transceiver apparatus and returns to the sleep mode. The communication device may, in response to the detected paging message, enter a random access procedure, for example in TTI 6.

FIG. 6 shows a schematic diagram illustrating the transmission of a paging message according to a second example of the present invention. The paging occasion window 610 extends over TTIs 0 to 9, for example subframes 0 to 9 in a radio frame in a LTE-based system. The length of the paging detection window 612 is set to 3 TTIs. The paging detection window starts at TTI 2, i.e. the CCA procedure failed in TTIs 0 and 1 and passed only in TTI 2 at the access node. The access node starts DL transmission in TTI 2. The communication device searches for DL transmission in TTIs 0 and 1, and for a paging message in TTIs 2, 3 and 4. Obviously, no paging message has been detected in TTIs 2 and 3, and the communication device stays active over the full length of the paging detection window. The communication device returns to the sleep mode in TTI 5, regardless whether or not a paging message has been detected in TTI 4. In other words, the communication device wakes up in TTI 0 for paging detection and stays active until and in TTI 4 for paging detection, before it deactivates its transceiver apparatus and returns to the sleep mode. In case, a paging message has been detected in TTI 4, the communication device may enter a random access procedure, for example in TTI 9.

FIG. 7 shows a schematic diagram illustrating the transmission of a paging message according to a third example of the present invention. The paging occasion window 710 extends over TTIs 0 to 9, for example subframes 0 to 9 in a radio frame in a LTE-based system. The CCA procedure at the access node has failed in TTI 0 and DL transmission starts only in TTI 1. The paging detection window 712 is offset from the beginning of the DL transmission in by five TTIs, starts in TTI 6 and extends over three TTIs. In other words, the communication device searches for DL transmission in TTIs 0 and 1, and returns to sleep mode in TTIs 2 to 5 after having detected the beginning of the DL transmission in the paging occasion window. The communication device awakes again in TTI 6, detects a paging message in TTI 6 and returns to the sleep mode after TTI 6. In other words, the communication device wakes up in TTI 0 and 6 for paging detection and stays active in TTI 1 for paging detection. The communication device may, in response to the detected paging message, enter a random access procedure.

It should be understood that each block of the flowchart of the Figures and any combination thereof may be implemented by various means or their combinations, such as hardware, software, firmware, one or more processors and/or circuitry.

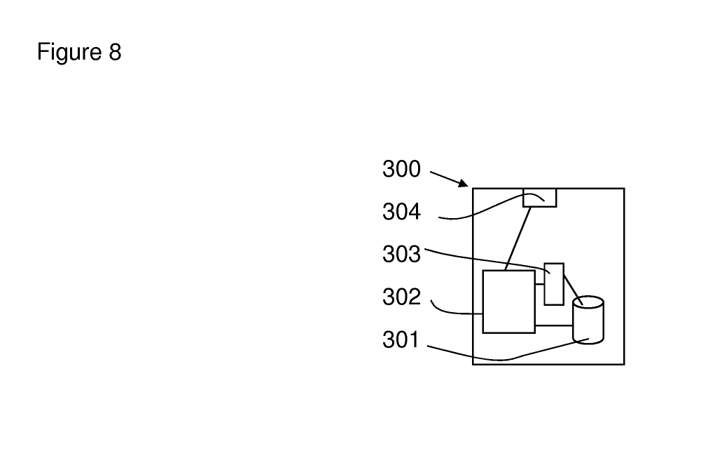

The method may be implemented on a mobile device as described with respect to FIG. 2 or control apparatus as shown in FIG. 8. FIG. 8 shows an example of a control apparatus for a communication system, for example to be coupled to and/or for controlling a station of an access system, such as a RAN node, e.g. a base station, (e) node B or 5G AP, a central unit of a cloud architecture or a node of a core network such as an MME or S-GW, a scheduling entity, or a server or host. The method may be implanted in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the control apparatus 300 can be configured to execute an appropriate software code to provide the control functions. Control functions may comprise providing and using configuration information for the paging detection window.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to LTE networks, similar principles may be applied in relation to other networks and communication systems, for example, 5G networks. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1-40. (canceled)

41. An apparatus comprising:
at least one processor; and
at least one memory including computer program code, the at least one memory and the computer program code configured, with the at least one processor, to cause the apparatus to perform at least the following:
detect at a user equipment a downlink transmission in a selected cell of a mobile communication system within a paging occasion window comprising two or more transmission time intervals, wherein the downlink transmission is subject to a clear channel assessment procedure;
determine a paging detection window comprising one or more transmission time intervals within the paging occasion window relative to the beginning of the detected downlink transmission; and
monitor the downlink transmission for receiving a paging message to the user equipment for the duration of the paging detection window or until the paging message is received, whichever occurs first.

42. An apparatus according to claim 41, and the at least one memory and the computer program code further configured, with the at least one processor, to cause the apparatus to perform at least the following:
receive first configuration information of the paging detection window in broadcast information provided in the mobile communication system; and
store the first configuration information.

43. An apparatus according to claim 42, wherein the first configuration information is cell-specific configuration information.

44. An apparatus according to claim 41, wherein the first configuration information comprises at least one of:
information indicative of the length of the paging detection window, and
information indicative of the beginning of the paging detection window.

45. An apparatus according to claim 41, and the at least one memory and the computer program code further configured, with the at least one processor, to cause the apparatus to receive and store second configuration information of the paging detection window, wherein the second configuration information is user-specific configuration information.

46. An apparatus according to claim 45, wherein the second configuration information comprises at least one of:
information indicative of the length of the paging detection window, and
information indicative of the beginning of the paging detection window.

47. An apparatus according to claim 45, and the at least one memory and the computer program code further configured, with the at least one processor, to cause the apparatus to use information from the second configuration information, if available.

48. An apparatus according to claim 40, wherein the user equipment is in idle mode.

49. An apparatus comprising:
at least one processor; and
at least one memory including computer program code, the at least one memory and the computer program code configured, with the at least one processor, to cause the apparatus to perform at least the following:
cause a downlink transmission from an access node in a cell of a mobile communication system within a paging occasion window comprising two or more transmission time intervals, wherein the downlink transmission is subject to a clear channel assessment procedure;
determine a paging detection window comprising one or more transmission time intervals within the paging occasion window relative to the beginning of the downlink transmission; and
cause transmission of a paging message to a user equipment within the paging detection window.

50. An apparatus according to claim 49, and the at least one memory and the computer program code further configured, with the at least one processor, to cause the apparatus to cause transmission of first configuration information of the paging detection window to the user equipment in broadcast information provided in the mobile communication system.

51. An apparatus according to claim 50, wherein the first configuration information is cell-specific configuration information.

52. An apparatus according to claim 49, wherein the first configuration information comprises at least one of:
information indicative of the length of the paging detection window, and
information indicative of the beginning of the paging detection window.

53. An apparatus according to claim 49, and the at least one memory and the computer program code further configured, with the at least one processor, to cause the apparatus to cause transmission of second configuration information of the paging detection window to the user equipment, wherein the second configuration information is user-specific configuration information.

54. An apparatus according to claim 53, wherein the second configuration information comprises at least one of:
information indicative of the length of the paging detection window, and
information indicative of the beginning of the paging detection window.

55. An apparatus according to claim 53, and the at least one memory and the computer program code further configured, with the at least one processor, to cause the apparatus to use information from the second configuration information, if available.

56. An apparatus according to claim 49, wherein the user equipment is in idle mode.

57. A method comprising:
detecting at a user equipment a downlink transmission in a selected cell of a mobile communication system within a paging occasion window comprising two or more transmission time intervals, wherein the downlink transmission is subject to a clear channel assessment procedure;
determining a paging detection window comprising one or more transmission time intervals within the paging occasion window relative to the beginning of the detected downlink transmission; and
monitoring the downlink transmission for receiving a paging message to the user equipment for the duration of the paging detection window or until the paging message is received, whichever occurs first.

58. A method comprising:
causing a downlink transmission from an access node in a cell of a mobile communication system within a paging occasion window comprising two or more transmission time intervals, wherein the downlink transmission is subject to a clear channel assessment procedure;
determining a paging detection window comprising one or more transmission time intervals within the paging occasion window relative to the beginning of the downlink transmission; and
causing transmission of a paging message to a user equipment within the paging detection window.

59. A non-transitory computer readable medium storing a program of instructions, execution of which by processor causes an apparatus to perform the method of claim 57.

60. A non-transitory computer readable medium storing a program of instructions, execution of which by processor causes an apparatus to perform the method of claim 58.
